(19) United States
(12) Patent Application Publication
(10) Pub. No.: US 2010/0073939 A1
(43) Pub. Date: Mar. 25, 2010

(54) Roadway luminaire system

(75) Inventors: Rick Kauffman, Buford, GA (US); Edward Bilson, Germanton, TN (US); Barbara Bilson, Germantown, TN (US); Gerald Ballard, Brandon, MS (US)

Correspondence Address: HOFFMANN & BARON, LLP, 6900 JERICHO TURNPIKE, SYOSSET, NY, 11791, US

(73) Assignee: Howard Industries, Inc.

(21) Appl. No.: 12/284,354

(22) Filed: Sep. 19, 2008

(51) Int. Cl. F21V 7/00; F21V 21/00; F21V 15/00

(52) U.S. Cl. 362/341; 362/371; 362/362

(57) ABSTRACT

A roadway luminaire generally includes a housing and a door pivotably connected to the housing. The housing includes a rear wall having an opening sized and shaped to receive a mounting arm for mounting the luminaire thereto, a top wall extending from the rear wall and an arm receiving channel formed in the top wall adjacent the rear wall for receiving an end of the mounting arm. The channel is formed with a step arrangement having a plurality of steps ascending in order along a length of the channel. The steps permit angular mounting adjustment of the housing with respect to the mounting arm depending on which step the end of the mounting arm rests.

### CROSS-REFERENCE TO RELATED APPLICATION

This application claims the benefit of U.S. Provisional Application No. 60/837,221, filed Sep. 21, 2007, which is incorporated herein by reference in its entirety for all purposes.

### BACKGROUND OF THE INVENTION

The present invention relates to luminaires for roadway lighting, and more particularly to a roadway luminaire having improved mounting adjustability and photometrics, and is easier to manufacture and assemble, as compared to conventional prior art roadway luminaires.

Luminaires with horizontally mounted lamps are generally used to illuminate roadways from a location on the side of the road or from the center if a median is present. These types of luminaires are sometimes called cobraheads since their shape resembles that of the head of a cobra.

Typically, roadway luminaires consist of a cast aluminum housing, a cast aluminum door, control gear to operate a lamp, usually a high intensity discharge lamp, an optical or reflector system to project the light in a desired distribution and direction, and a mounting means to attach it to an arm that is attached to a pole or the side of a structure.

Within the American National Standards Institute (ANSI) there is a committee, C136, which publishes standards defining some of the mechanical and electrical requirements for this type of lighting equipment. The relevant standards to this invention are: C136.2 (American National Standard for Roadway and Area Lighting Equipment—Luminaire Voltage Classification), C136.3 (American National Standard for Roadway and Area Lighting Equipment—Luminaire Attachments), C136.10 (American National Standard for Roadway and Area Lighting Equipment—Locking-type Photocontrol and Mating Devices—Physical and Electrical Interchangeability and Testing), C136.14 (American National Standard for Roadway and Area Lighting Equipment—for Elliptically Shaped, Enclosed Side-mounted Luminaires for Horizontal-burning High-intensity Discharge Lamps), and C136.17 (American National Standard for Roadway and Area Lighting Equipment—Enclosed Side-mounted Luminaires for Horizontal-burning High-intensity Discharge Lamps—Mechanical Interchangeability of Refractors).

Also, the Illumination Engineering Society of North America (IESNA) also publishes a standard defining the classifications of light patterns for a roadway luminaire which are useful to lighting practitioners in properly applying this equipment. The relevant standard is ANSI/IESNA RP-8-2005, American National Standard Practice for Roadway Lighting.

### SUMMARY OF THE INVENTION

The present invention is a roadway luminaire generally including a housing and a door pivotably connected to the housing. The housing includes a rear wall having an opening sized and shaped to receive a mounting arm for mounting the luminaire thereto, a top wall extending from the rear wall and an arm receiving channel formed in the top wall adjacent the rear wall for receiving an end of the mounting arm. The channel is formed with a step arrangement having a plurality of steps ascending in order along a length of the channel. The steps permit angular mounting adjustment of the housing with respect to the mounting arm depending on which step the end of the mounting arm rests.

In a preferred embodiment, the steps have a height to permit 1.5° increments of angular mounting adjustment. The step arrangement also preferably includes eight steps including a center step. The opening in the rear wall is preferably defined by an orthogonal centerline axis and a top-most edge adjacent the top wall, wherein a plane defined between the center step of the step arrangement and the top-most edge of the rear wall opening is parallel with the centerline axis of the rear wall opening. Thus, the step arrangement preferably includes four steps on a distal side of the center step proximal the rear wall opening. The channel further preferably includes a floor extending between the rear wall opening and a first of the three steps on the proximal side of the center step.

The channel further preferably includes a stop arrangement disposed at a distal end of the channel adjacent a last step of the step arrangement opposite the rear wall opening. The stop arrangement preferably includes at least one banking pin extending above the last step of the step arrangement for engaging the end of the mounting arm to prevent further insertion of the mounting arm in the housing.

In another embodiment, the housing of the luminaire includes a unique reflector adapted to optically perform with both a flat lens and a prismatic drop lens. The reflector includes a generally spherical side wall defining an opening and terminating at a top edge opposite the opening, a concave ring portion extending from the top edge of the sidewall in a direction radially inward and in a direction back toward the reflector opening and terminating at an inner edge and a generally spherical top portion connected to the inner edge of the ring portion, wherein at least a portion of the top portion is axially sunken within the sidewall.

In another embodiment, the housing has a strike plate disposed at a forward end thereof and the door has a pocket member disposed at a forward end thereof. The pocket member includes a wall forming a passage and having two torsion spring apertures extending through the wall and communicating with the passage. A latch assembly is provided, which is insertable in the door pocket member passage. The latch assembly includes a latch member, a pivot pin removably attached to the latch member and a torsion spring engaged between the latch member and the pivot pin. The latch member has a hook end engageable with the housing strike plate and a transverse through-hole formed therethrough for removable insertion of the pivot pin. The torsion spring has two engagement ends received within the torsion spring apertures of the door pocket member when the latch assembly is inserted in the pocket member passage. In this manner, the latch member, the pivot pin and the torsion spring can be pre-assembled together prior to the latch assembly being inserted in the door pocket member.

In another embodiment, the door has a floor and a perimeter wall extending generally perpendicularly from the floor. The perimeter wall has a bottom wall portion disposed at the rearward end of the door, a top wall portion opposite the bottom wall portion and sidewall portions connecting the top wall portion and the bottom wall portion. A ballast is mounted to the floor adjacent the bottom wall portion, wherein the ballast is substantially equidistant to the side wall portions. A first electrical component is mounted to the door on a first side of the ballast and a second electrical component is mounted to the door on a second side of the ballast opposite the first side.

In a preferred form of this embodiment, the ballast is also mounted to the bottom wall portion of the door, and the ballast is preferably in thermal contact with the floor and the bottom wall portion of the door for dissipating heat from the ballast to the door. In this regard, the floor and/or the bottom wall portion of the door preferably include at least one raised landing integrally formed thereon, wherein the ballast is mounted to the landing. At least one mounting fastener connects the ballast to the landing, wherein the fastener is in thermal contact with the ballast and the landing for conducting heat therebetween.

A preferred form of the roadway luminaire, as well as other embodiments, objects, features and advantages of this invention, will be apparent from the following detailed description of illustrative embodiments thereof, which is to be read in conjunction with the accompanying drawings.

### BRIEF DESCRIPTION OF THE DRAWINGS

FIG. 1 is a profile view of the invention showing its overall dimensions and unique profile.

FIG. 2 is a bottom view with the door removed showing the lamp and other component placement.

FIG. 3 is a view of the inside of the door showing the ballast and related component attachment.

FIG. 4 is a close-up view of the ballast area showing the unique mounting of a smaller ballast with heat-sinking features.

FIG. 5 is a cross-sectional view of the latching mechanism taken along line 5-5 of FIG. 1.

FIG. 5a is a cross-sectional view of the latch receiving aperture of the latch pocket formed on the housing.

FIG. 6 shows the hinging detail.

FIG. 7 is an enlarged cross-sectional view of the area shown in FIG. 5 showing the close fit between the housing and door.

FIG. 8 is a cross-sectional view of the upper housing taken along the line 8-8 of FIG. 2, showing the stepped leveling arrangement and the opening for the arm.

FIG. 9 is a cross-sectional view of the reflector detail taken along the line 9-9 of FIG. 2.

FIG. 10 is a close-up view of the ballast area showing the unique mounting of a larger ballast with heat-sinking features.

FIG. 11 is a detailed perspective view of the latch according to the present invention.

### DETAILED DESCRIPTION OF THE PREFERRED EMBODIMENTS

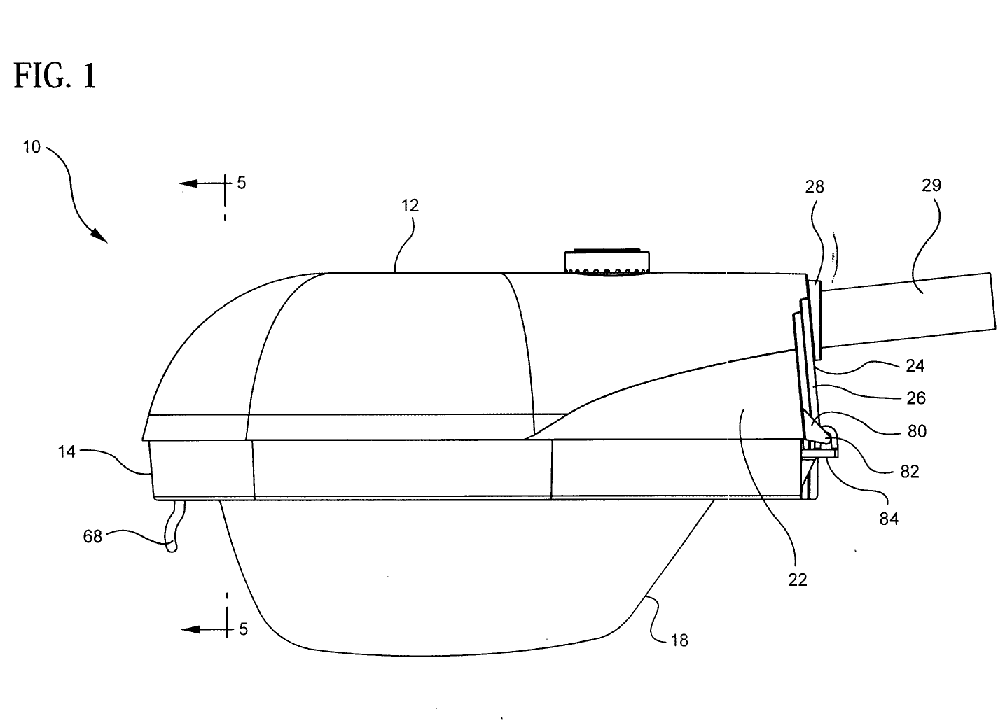

Referring first to FIGS. 1-3, the luminaire 10 of the present invention generally includes a luminaire housing 12, a door 14 hinged to the housing, a reflector 16 supported within the housing and a lens or refractor 18 retained within the door. A gasket 20 surrounds the reflector 16 and provides a seal between the housing 12 and the door 14.

In FIG. 1, it is shown that the housing or body of the luminaire is about 20.7 inches long and, with the refractor 18, it is about 10.5 inches high. Without the refractor 18 and with a flat lens (not shown), the luminaire 10 is about 6.5 inches high. The overall shape is somewhat elliptical with flat side flares 22 formed on the housing 12 to give it a distinctive look.

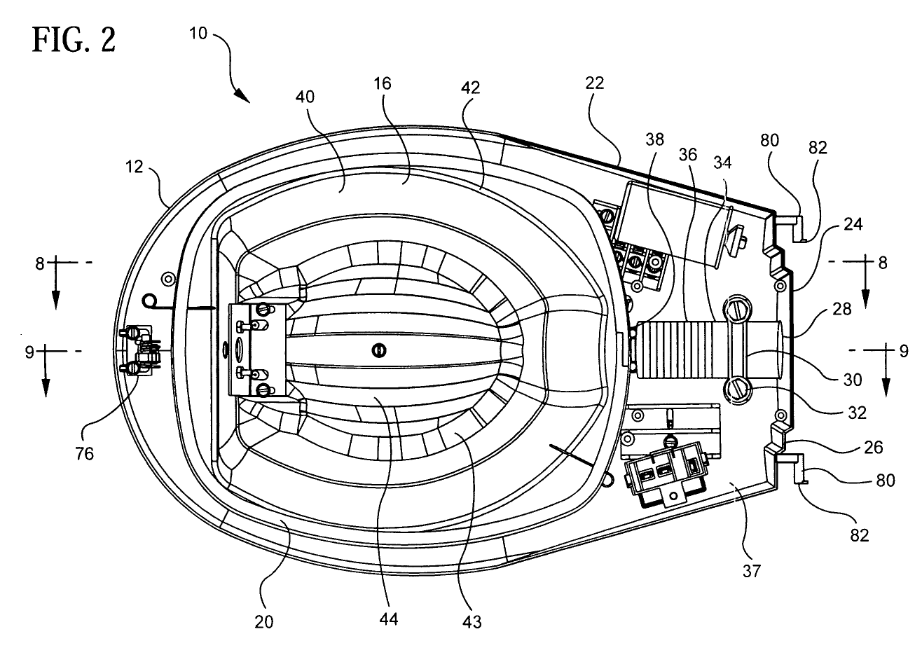

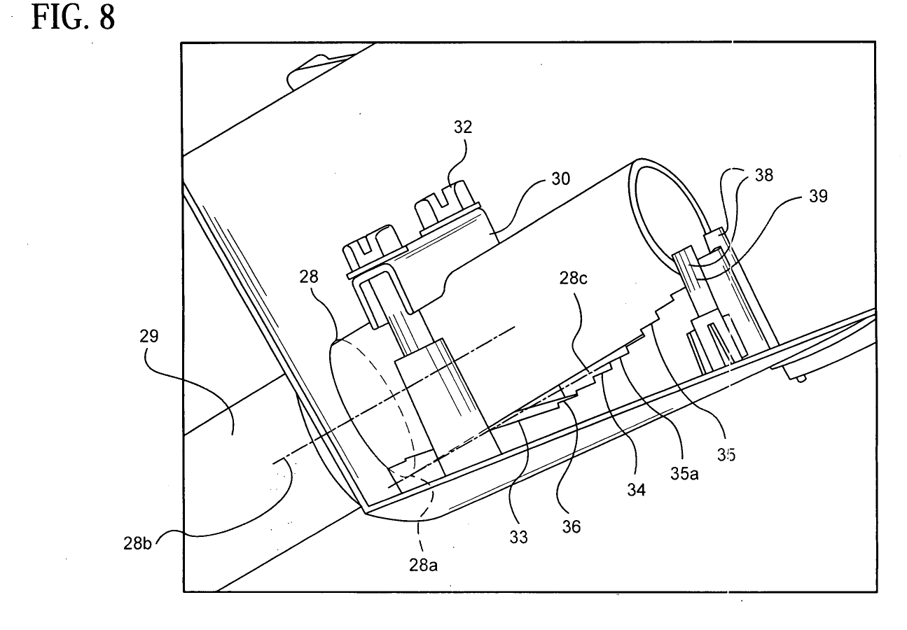

The housing 12 further includes a rear wall 24 formed with several stepped offsets 26. The offsets 26 are stepped in the lateral direction to stiffen the rear wall 24 and also provide a unique appearance. Referring to FIGS. 2 and 8, showing the inside of the upper housing 12, the stepped design 26 of the rear wall 24 can be more clearly seen.

The rear wall 24 further includes an opening 28 through which a mounting arm 29 is inserted for mounting the luminaire to a pole. The common means of roadway luminaire attachment to an arm 29 is by clamping onto the outside of the arm using a clamp bracket 30, known as a fitter clamp, and using two bolts 32 to secure the arm within an arm receiving channel 36 cast within a top wall 37 of the housing 12.

In the present invention, however, the arm receiving channel 36 of the housing is formed with a step arrangement 34 cast within the arm receiving channel 36 of the housing 12. As shown most clearly in FIG. 8, the arm receiving channel 36 starts at the mounting pole opening 28 and includes a floor 33 intersecting with the upper edge 28a of the mounting pole opening and extends at a radially outward angle from the centerline 28b of the mounting pole opening. The floor 33 terminates at the step arrangement 34, which preferably includes eight steps 35 arranged in ascending order back toward the mounting pole centerline 28b. The fourth step 35a, in ascending order beginning from the floor 33 of the channel 36, is aligned with the upper edge 28a of the mounting arm opening 28, such that a level plane 28c is defined between the fourth step 35a and the upper edge 28a of the mounting hole opening, which is parallel with the centerline 28b of the mounting hole opening. In this manner, when the pole 29 rests on the fourth step 35a, a 0° reference plane for the housing 12 is defined.

The height of the steps 35 are chosen to allow 1.5° increments of adjustment depending on which step the pole rests. Thus, the eight steps 35 of the stepped arrangement 34 of the receiving channel 36 of the present invention allows for ±6° of leveling adjustment. For example, the housing 12 can be adjusted to a +3° angle by positioning the mounting pole 29 on the sixth step 35 (i.e., the second step beyond the fourth step 35a). Alternatively, the housing can be mounted at a −6° angle by positioning the mounting pole on the floor 33 of the mounting channel 36. In any event, the pole 29 is secured within the channel by tightening the bolts 32 of the clamp 30, once the desired angle is selected.

The housing 12 further includes a stop arrangement 38, which prevents the arm 29 from being inserted too far within the housing. The stop arrangement 38 preferably takes the form of one or more banking pins 39 integrally cast with the housing at the end of the arm receiving channel 36 opposite the arm opening 28. The pins 39 contact the end of the arm 29 when the arm has reached the far end of the arm receiving channel 36 and serve to stop further insertion of the arm. Again, this can be seen most clearly in FIG. 8.

The arm receiving opening 28 in the rear wall 24 is sized for clearance around a 1¼ inch NPS pipe arm 29. This is equal to a diameter of 1.660 inches. The close tolerance opening reduces entry of contaminants. With the aid of a gasket 20 the luminaire can be rated IP66.

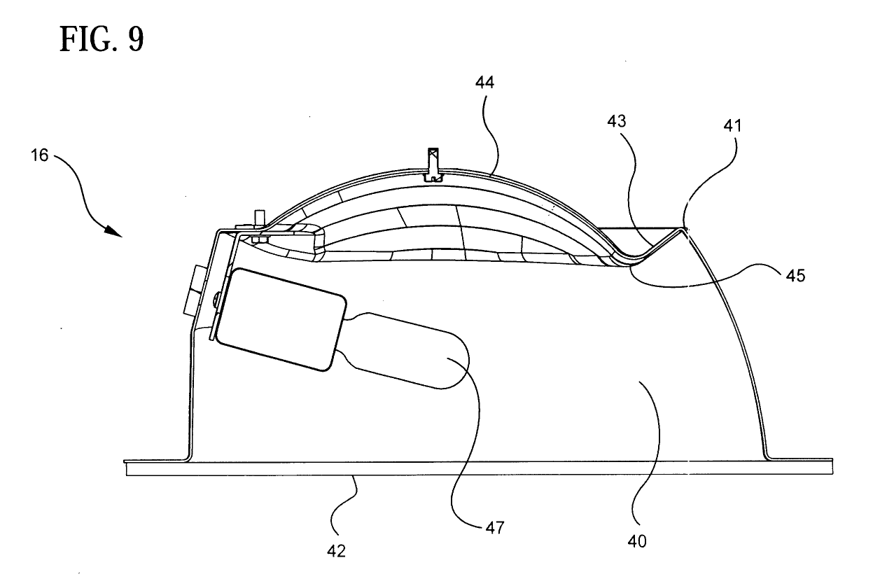

FIG. 2 shows the contours of the reflector 16, which provide a very good and uniform light distribution pattern, and FIG. 9 shows a cross-section of the reflector detail. The reflector 16 includes a generally spherical sidewall 40 defining an opening 42 and terminating an edge 41 opposite the opening. Extending from the edge 41 of the sidewall 40 opposite the opening 42 is a concave ring portion 43. The concave ring portion 43 extends from the top edge 41 of the sidewall 40 opposite the opening 42 in a direction radially inward and in a direction back toward the reflector opening 42. The concave ring portion 43 connects with a reflector top 44 at an inner edge 45 of the concave ring portion to complete the reflector 16. The top 44 has a generally convex spherical shape matching the sidewall 40, but is axially offset with respect to the sidewall due to the concave ring portion 43. Specifically, the concave ring portion 43 interposed between the sidewall 40 and the top 44 axially translates the top with respect to the sidewall, so that at least a portion of the top is axially sunken within the sidewall. In other words, the concave ring portion 43 makes the top 44 of the reflector 16 appear to be collapsed within the reflector to a certain degree. It has been surprisingly found that by “collapsing” the spherical top 44 within the spherical sidewall 40, a reflector 16 is provided having improved dual functuality in terms of its performance with either a flat lens or a prismatic drop lens.

The side walls 40 of the reflector 16, near the opening 42, are defined by a series of points of which the normal to the surface at that point is positioned to direct the light up and down the roadway at the desired levels. The top 44 of the reflector 16 is unique in that it directs light into the lower portions of the side walls 40 and out of the opening 42 at higher vertical angles providing a more uniform distribution of the light and eliminating a bright spot directly under the luminaire 10. Due to the way the light rays are directed out of the reflector 16, it performs optimally with either a flat lens or a prismatic drop lens.

As also shown in FIG. 9, a lamp 47 is mounted on the street side so that the house side of the reflector is free to direct light toward the street side. The center of the lamp light source 47 is positioned vertically and horizontally within the reflector 16 so as to direct most of the light up and down the roadway about 3 mounting heights. The top 44 of the reflector is designed to redirect the light into the sides 40 of the reflector 16 to reinforce the light up and down the roadway and minimize the light directly beneath the luminaire.

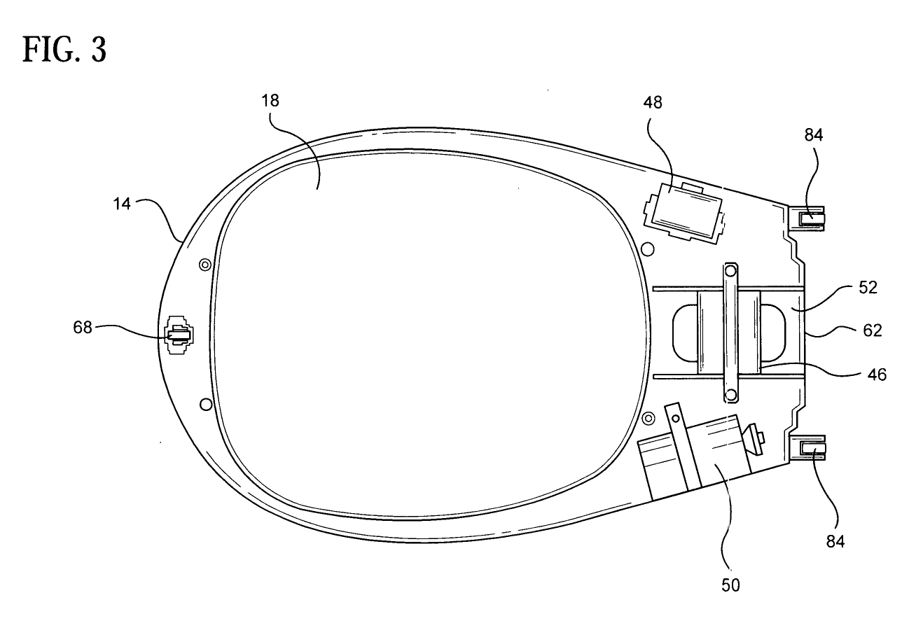

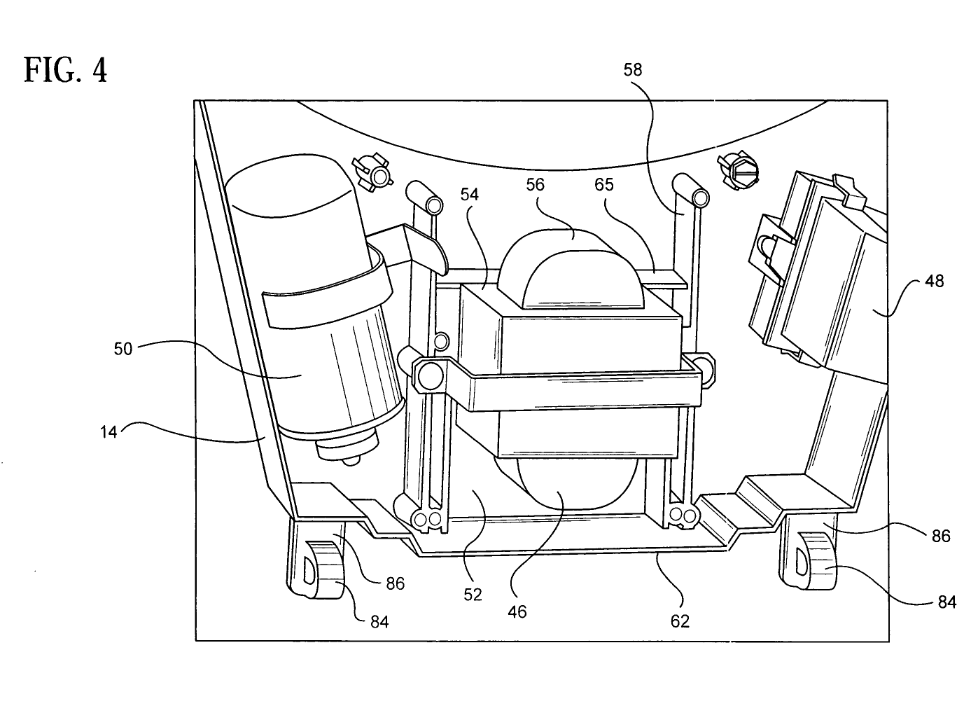

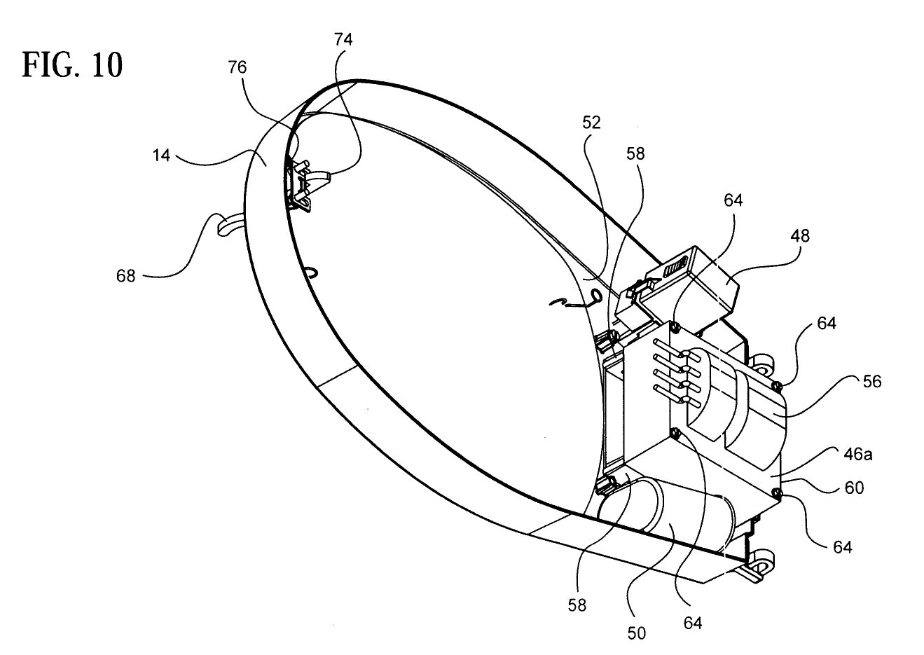

FIG. 3 shows the door assembly 14 and the component placement. The electrical components of the luminaire 10 generally include a ballast 46, a starter 48 and a capacitor 50, which are all preferably mounted to the door assembly 14. The ballast 46 is generally the heaviest part of the assembly and is mounted in the center of the door 14 for balance. Smaller ballasts 46, such as the one shown in FIGS. 3 and 4, are in thermal contact with the bottom floor 52 of the door 14 for heat dissipation. Larger ballasts 46a, such as the one shown in FIG. 10, mount with the face of the ballast laminations 54 containing the coils 56 on vertical ribs 58 formed on the floor 52 of the door 13. Moreover, the bottom edge 60 of the laminations 54 abut against the back wall 62 for additional heat dissipation. Furthermore, the four screws 64 through the laminations 54 also contribute to the heat flow out of the ballast 46a.

The floor 52 of the door 14 is also preferably formed with additional horizontal ribs 65 to facilitate mounting of the smaller ballast 46, as shown in FIG. 4. The horizontal ribs 65 span between the vertical ribs 58 and abut against the laminations 54 of the ballast 46 to prevent the ballast from moving in the vertical direction.

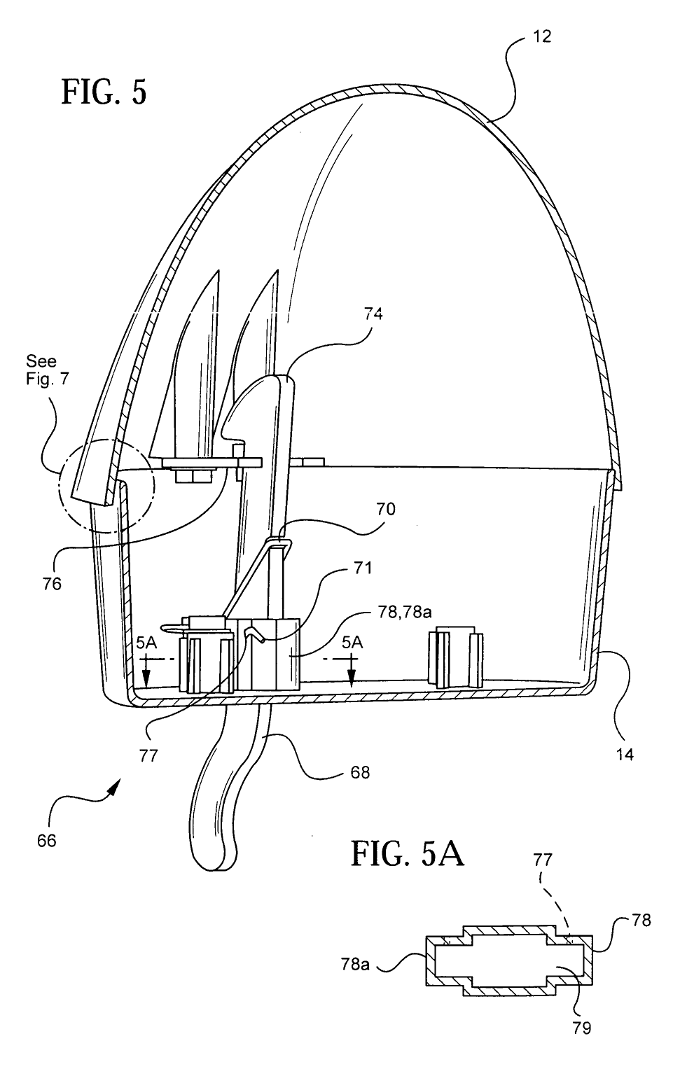

Turning now to FIGS. 5, 10 and 11, an improved latch mechanism 66 according to the present invention is shown. The latch mechanism includes a trigger style latch member 68, a torsion spring 70 and a pin 72 received within a hole 73 formed laterally through the latch member. When assembled to the door 14, the torsion spring 70 keeps the hook end 74 of the trigger style latch member 68 engaged with a strike plate 76 formed on or assembled to the upper luminaire housing 12.

However, unlike prior art designs, the trigger latch 68 of the present invention is easy to install and requires no additional hardware. In particular, conventional prior art luminaire latch assemblies typically include a trigger latch member having a latch pivot pin integrally cast into the latch member. The latch is then fixedly secured to the door with two screws and two flat washers making assembly difficult.

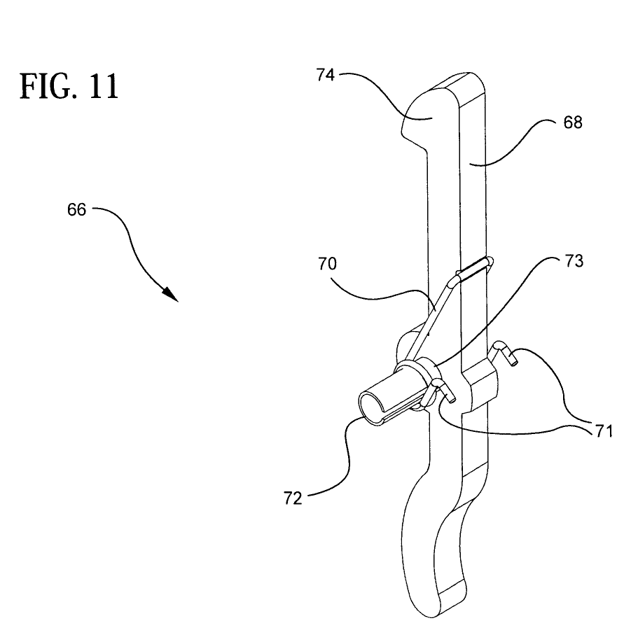

In contrast, the latch mechanism 66 according to the present invention includes a pivot pin 72 that slides through a hole 73 in the trigger latch member 68, which allows the torsion spring 72 to be assembled prior to inserting the pin. The latch-pin-spring assembly 66, as shown in its assembled form in FIG. 11, can then be inserted from the bottom side of the door 14 into a cast pocket 78 formed in the door.

As shown in FIG. 5a, the cast pocket 78 is defined by a perimeter wall 78a forming a passage 79 having a cross-shaped cross-section for receiving the latch assembly with pivot pin 72. The pocket further includes a pair of torsion spring apertures 77 formed transversely with the latch passage 79 for receiving the ends 71 of the torsion spring 70.

Upon installation, the pre-assembled latching mechanism 66 easily snaps into place within the pocket 78 without the need for any additional hardware. This is accomplished by squeezing the ends of the torsion spring 70 together, while inserting the latch assembly 66 through the aperture 79 of the pocket 78. At a certain point during insertion of the latch mechanism 66, the ends of the torsion spring 70 will become resident within the torsion spring apertures 79 of the pocket, thereby locking the latch mechanism 66 in place. When the door 14 is latched, the assembly 66 is in tension further securing it. Thus, no screws or washers are required, thereby saving time and material, and making installation simple and easy.

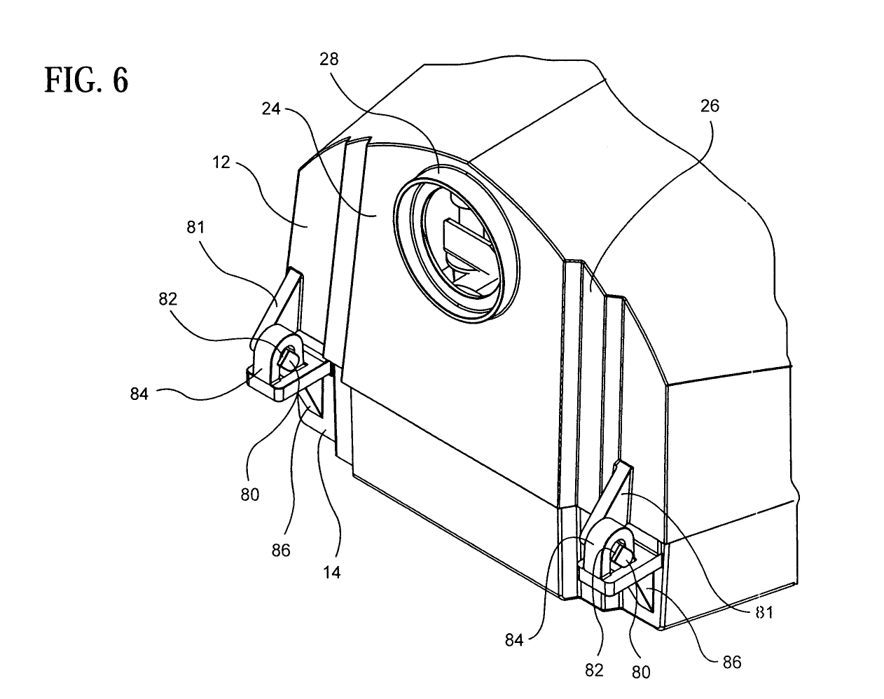

FIG. 6 shows the hinging arrangement of the present invention. Specifically, two hinge pins 80 are cast on the ends of brackets 81 formed on the upper housing 12. The brackets 81 are laterally spaced apart on the rear wall 24 of the housing. On the end of each pin 80 is a rectangular key 82. Loops 84 are cast onto supports 86 on the door 14 and inserted over the keys 82 and pins 80 on the housing 12. The door 14 will only go on and off of the hinge pins 80 when the loops 84 are aligned with the keys 82. This prevents accidental removal of the door 14.

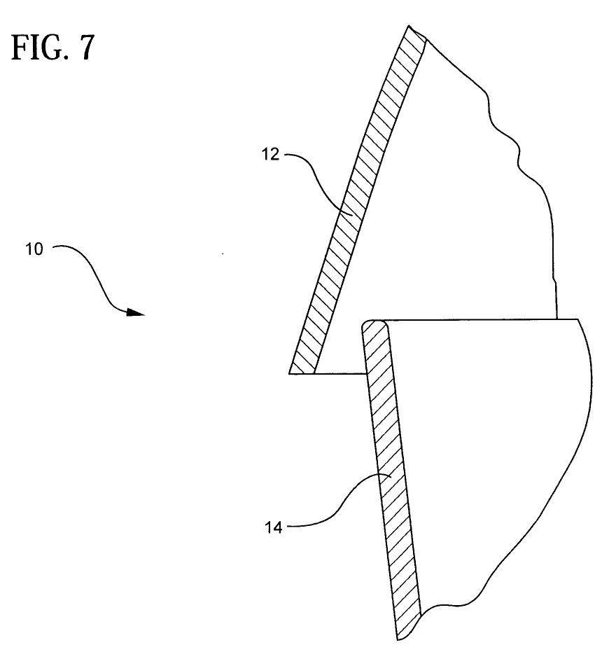

FIG. 7 shows the close fit tolerance between the housing 12 and the door 14. This minimizes the entry of contaminants into the luminaire 10 and with the aid of the gasket 20 renders the luminaire dust and water tight. The industry term for this is IP66, IP stands for Ingress Protection and the first digit denotes protection against entry of solid objects of 0.1 mm in diameter or greater and the second digit denotes protection from liquid entry by a forced stream from a 0.375 inch diameter nozzle with 3 meters of pressure head.

As a result of the present invention, a roadway luminaire for general roadway lighting is provided. The luminaire of the present invention incorporates a high intensity discharge lamp system in a very small housing and meets industry requirements. The luminaire of the present invention is of the smallest possible size to house all of the necessary components in the proper configuration to meet industry requirements. In particular, for this series, the largest is a 250 watt high pressure sodium lamp with an E-18 envelope as defined by ANSI C78.42-2001 (American National Standard for Electric Lamps—Guidelines for High-pressure Sodium Lamps) along with its necessary ballast, capacitor, lampholder, reflector, terminal block, wiring and mounting means. The invention has the shortest length of any similar product on the market.

The invention further utilizes a unique means of mounting the ballast to operate it at lower temperatures than in other versions of this product currently on the market. The ballast is mounted at the bottom center of the luminaire to give it greater balance and a lower center of gravity with respect to its mounting means. Further, the ballast and serviceable components are mounted on the door for easier servicing or replacement.

The roadway luminaire of the present invention further includes a ballast mounted within the luminaire door so as to extract heat from two directions simultaneously so that the ballast can operate in a smaller space below maximum allowable temperatures. The ballast is preferably mounted in the bottom center of the door so as to balance the unit and lower the center of gravity. The ballast and related components are also preferably mounted to the door for easy servicing or replacement.

The luminaire of the present invention further preferably includes an upper housing and a lower door connected by a hinge mechanism with a keyed arrangement so that the door cannot accidentally disconnect from the upper housing in any position except at a particular angle.

The luminaire of the present invention further preferably utilizes a specially designed reflector to provide better than normal photometric performance with either a flat lens or a convex prismatic lens. In general, the luminaire system of the present invention has an optical system of such configuration so as to perform optimally with either a drop lens refractor or a flat lens.

The luminaire of the present invention further preferably includes a unique latching arrangement to provide closure between housing and door so that no fasteners are required to secure the latch itself to the door or housing.

The luminaire of the present invention also preferably has a means of leveling the luminaire ±6° from horizontal to compensate for pole and arm misalignment with respect to the roadway.

Although illustrative embodiments of the present invention have been described herein with reference to the accompanying drawings, it is to be understood that the invention is not limited to those precise embodiments, and that various other changes and modifications may be effected by one skilled in the art without departing from the scope or spirit of the invention.

What is claimed is:

1. A roadway luminaire housing comprising:
a rear wall having an opening sized and shaped to receive a mounting arm for mounting the luminaire thereto;
a top wall extending from said rear wall; and
an arm receiving channel formed in said top wall adjacent said rear wall for receiving an end of the mounting arm, said channel being formed with a step arrangement having a plurality of steps ascending in order along a length of said channel, said steps permitting angular mounting adjustment of said housing with respect to the mounting arm depending on which step the end of the mounting arm rests.

2. A roadway luminaire as defined in claim 1, wherein said steps have a height to permit 1.5° increments of angular mounting adjustment.

3. A roadway luminaire as defined in claim 1, wherein said step arrangement comprises eight steps including a center step, and wherein said opening in said rear wall is defined by an orthogonal centerline axis and a top-most edge adjacent said top wall, wherein a plane defined between said center step of said step arrangement and said top-most edge of said rear wall opening is parallel with said centerline axis of said rear wall opening.

4. A roadway luminaire as defined in claim 3, wherein said step arrangement comprises four steps on a distal side of said center step opposite said rear wall opening and three steps on a proximal side of said center step proximal said rear wall opening.

5. A roadway luminaire as defined in claim 4, wherein said channel further comprises a floor extending between said rear wall opening and a first of said three steps on said proximal side of said center step.

6. A roadway luminaire as defined in claim 5, wherein said channel further comprises a stop arrangement disposed at a distal end of said channel adjacent a last step of said step arrangement, opposite said rear wall opening, for engaging the end of the mounting arm to prevent further insertion of the mounting arm in said housing.

7. A roadway luminaire as defined in claim 6, wherein said stop arrangement comprises at least one banking pin extending above said last step of said step arrangement.

8. A reflector for a roadway luminaire comprising:
a generally spherical side wall defining an opening and terminating at a top edge opposite said opening;
a concave ring portion extending from said top edge of said sidewall in a direction radially inward and in a direction back toward said reflector opening and terminating at an inner edge; and
a generally spherical top portion connected to said inner edge of said ring portion, wherein at least a portion of said top portion is axially sunken within said sidewall.

9. A reflector as defined in claim 8, wherein said reflector is adapted to optically perform with both a flat lens and a prismatic drop lens.

10. A roadway luminaire comprising:
a housing having a strike plate disposed at a forward end thereof;
a door pivotally connected to said housing at a rearward end thereof, said door having a pocket member disposed at a forward end thereof, said pocket member including a wall forming a passage and having two torsion spring apertures extending through said wall and communicating with said passage; and
a latch assembly insertable in said door pocket member passage, said latch assembly including a latch member, a pivot pin removably attached to said latch member and a torsion spring engaged between said latch member and said pivot pin, said latch member having a hook end engageable with said housing strike plate and a transverse through-hole formed therethrough for removable insertion of said pivot pin, said torsion spring having two engagement ends received within said torsion spring apertures of said door pocket member when said latch assembly is inserted in said pocket member passage, wherein said latch member, said pivot pin and said torsion spring can be pre-assembled together prior to said latch assembly being inserted in said door pocket member.

11. A roadway luminaire as defined in claim 10, wherein said passage of said pocket member has a cross-shaped cross-section, wherein said latch assembly snap-fits within said passage.

12. A roadway luminaire comprising:
a housing having a rearward end;
a door having a rearward end pivotably connected to said rearward end of said housing, said door having a floor and a perimeter wall extending generally perpendicularly from said floor, said perimeter wall having a bottom wall portion disposed at said rearward end of said door, a top wall portion opposite said bottom wall portion and sidewall portions connecting said top wall portion and said bottom wall portion;
a ballast mounted to said floor adjacent said bottom wall portion, said ballast being substantially equidistant to said side wall portions;
a first electrical component mounted to said door on a first side of said ballast; and
a second electrical component mounted to said door on a second side of said ballast opposite said first side.

13. A roadway luminaire as defined in claim 12, wherein said ballast is also mounted to said bottom wall portion of said door.

14. A roadway luminaire as defined in claim 12, wherein said ballast is in thermal contact with said floor and said bottom wall portion of said door for dissipating heat from said ballast to said door.

15. A roadway luminaire as defined in claim 14, wherein said floor of said door includes at least one raised landing integrally formed thereon, said ballast being mounted to said landing.

16. A roadway luminaire as defined in claim 14, wherein said bottom wall portion includes at least one raised landing integrally formed thereon, said ballast being mounted to said landing.

17. A roadway luminaire as defined in claim 15, wherein said bottom wall portion includes at least one raised landing integrally formed thereon, said ballast being mounted to said landing.

18. A roadway luminaire as defined in claim 15, further comprising at least one mounting fastener connecting said ballast to said landing, said mounting fastener being in thermal contact with said ballast and said landing for conducting heat therebetween.

19. A roadway luminaire as defined in claim 12, wherein said housing includes a strike plate disposed at a forward end thereof and said door includes a pocket member disposed at a forward end thereof, said pocket member including a wall forming a passage and having two torsion spring apertures extending through said wall and communicating with said passage, and wherein said luminaire further comprises a latch assembly insertable in said door pocket member passage, said latch assembly including a latch member, a pivot pin removably attached to said latch member and a torsion spring engaged between said latch member and said pivot pin, said latch member having a hook end engageable with said housing strike plate and a transverse through-hole formed therethrough for removable insertion of said pivot pin, said torsion spring having two engagement ends received within said torsion spring apertures of said door pocket member when said latch assembly is inserted in said pocket member passage, wherein said latch member, said pivot pin and said torsion spring can be pre-assembled together prior to said latch assembly being inserted in said door pocket member.

20. A roadway luminaire as defined in claim 12, wherein said housing further includes a reflector, said reflector comprising:
a generally spherical side wall defining an opening and terminating at a top edge opposite said opening;
a concave ring portion extending from said top edge of said sidewall in a direction radially inward and in a direction back toward said reflector opening and terminating at an inner edge; and
a generally spherical top portion connected to said inner edge of said ring portion, wherein at least a portion of said top portion is axially sunken within said sidewall.
